(19) United States
(12) Patent Application Publication
(10) Pub. No.: US 2005/0183834 A1
(43) Pub. Date: Aug. 25, 2005

(54) Hinge assembly

(76) Inventors: John Clifford Smallwood, Moorebank (AU); Terence John Windon, Chipping Norton (AU)

Correspondence Address: Ladas & Parry, 26 West 61 Street, New York, NY, 10023, US

(21) Appl. No.: 11/041,008

(22) Filed: Jan. 21, 2005

(30) Foreign Application Priority Data
Jan. 23, 2004 (AU) 2004900328

(51) Int. Cl. E05D 15/00

(52) U.S. Cl. 160/229.1

(57) ABSTRACT

A hinge assembly (20) having a generally horizontal pivot axis (40), the assembly (20) including:
a lower hinge member (21), said lower member (21) having a longitudinal recess (24) providing said axis (40) and a projection (25) extending longitudinally parallel to said axis (40), the projection (25) having a longitudinal substantially arcuate surface (26) spaced from said axis (40) by a fixed radius; and
an upper hinge member (31), said upper member (31) having a pivot portion (35) located in said recess (24) so that the members (21, 31) can pivot relative to each other about said axis (40), the upper hinge member (31) further having a cavity (38) into which said projection (25) extends and moves, said cavity (38) having an entrance portion (39) located at a fixed radius relative to said axis (40) and extending longitudinally parallel to said axis (40), the entrance portion (39) being located adjacent said substantially arcuate surface (26) of said lower member (21).

### FIELD OF THE INVENTION

The present invention relates to a hinge assembly, which is particularly useful for sectional overhead garage doors, but is not limited thereto.

### BACKGROUND OF THE INVENTION

Sectional overhead doors are typically installed in garages. Such doors usually include horizontally extending rectangular panels which are stacked top edge-to-bottom edge. The panels are connected on an inner side thereof by hinges at the panel ends and at mid-portions thereof such that the panels can pivot relative to each other. Attached to the panel end hinges are rollers running on tracks. The tracks have vertical sections which extend vertically along each side of a garage opening. The tracks extend into a curved section and into a horizontal section disposed adjacent the ceiling of the garage. The track and rollers allow the door panels to be moved from the vertical section where the door panels block the garage opening to the horizontal section of the track to allow passage through the opening.

Due to the pivoting of adjacent door panels, there is a potential that a person's fingers or other objects may be pinched between adjacent panel top and bottom edges, particularly when the panels move from the curved section of the track to the vertical section.

It is thus desirable to provide a hinge assembly for such sectional doors where insertion of a person's finger or other object between the panels is substantially prevented.

### SUMMARY OF THE INVENTION

In one aspect, the present invention provides a hinge assembly having a generally horizontal pivot axis, the assembly including:
a lower hinge member, said lower member having a longitudinal recess providing said axis and a projection extending longitudinally parallel to said axis, the projection having a longitudinal substantially arcuate surface spaced from said axis by a fixed radius; and
an upper hinge member, said upper member having a pivot portion located in said recess so that the members can pivot relative to each other about said axis, the upper hinge member further having a cavity into which said projection extends and moves, said cavity having an entrance portion located at a fixed radius relative to said axis and extending longitudinally parallel to said axis, the entrance portion being located adjacent said substantially arcuate surface of said lower member.

The projection preferably includes the substantially arcuate surface and a connection portion extending from the substantially arcuate surface to the recess. Preferably, the cavity in the upper hinge member is defined by a substantially arcuate surface extending from the entrance portion, and a connection portion extending from the substantially arcuate surface to the pivot portion. The connection portion is preferably flat.

The recess is preferably formed as a longitudinal substantially rounded socket. The pivot portion is preferably formed as a longitudinal substantially closed and substantially rounded projection.

Preferably, the lower hinge member includes an attachment portion at a bottom portion thereof for attachment to a sectional overhead door panel. The upper hinge member preferably includes an attachment portion at a top portion thereof for attachment to a sectional overhead door panel.

In another aspect, the present invention provides a sectional overhead door panel having the hinge assembly of the above, wherein the lower hinge member is attached to the top longitudinal edge of the door panel and the upper hinge member is attached to the bottom longitudinal edge of the door panel.

The door panel preferably forms an extension or part of the substantially arcuate surface of the lower hinge member. The door panel also preferably forms an extension or part of the entrance portion of the upper hinge member.

In another embodiment, the lower hinge member is integrally formed with the top longitudinal edge of the door panel and the upper hinge member is integrally formed with the bottom longitudinal edge of the door panel.

In another aspect, the present invention provides a sectional overhead door assembly to be mounted adjacent a building opening, the door assembly including
first and second generally parallel, transversely spaced and co-extensive tracks, each track having a substantially vertical section to extend along each side of the building opening, a substantially horizontal section to extend adjacent a ceiling of said building, and a curved section extending between the vertical and horizontal sections,
a plurality of door panels to each extend between said tracks, each door panel having a hinge assembly according to the above, each door panel having the lower hinge member at a top longitudinal edge thereof and the upper hinge member at a bottom longitudinal edge thereof such that each panel can be pivotably connected to an adjacent panel,
rollers to be mounted to ends of said hinge members to engage said tracks,
wherein, in use, the tracks and rollers allow the door panels to be moved from the track vertical section where the door panels block the building opening to the track horizontal section to allow passage through the opening.

The sectional overhead door assembly preferably further includes a weather adaptor substantially co-extensive with said door panels, the adaptor having the longitudinal recess and longitudinal projection of the lower hinge member, the adaptor to be attached to the lowermost panel of the assembly. The adaptor preferably includes a flat bottom portion. The adaptor bottom portion preferably includes a rubber sealing strip.

### BRIEF DESCRIPTION OF THE DRAWINGS

Preferred forms of the present invention will now be described with reference to the accompanying drawings, wherein:

FIG. 1 shows a cross-section of a first embodiment of a hinge assembly in accordance with the present invention, with FIGS. 1(a) to 1(h) showing sequential movement of the upper hinge member relative to the lower hinge member;

FIG. 2 shows (a) perspective view and (b) cross-section view of use of the first embodiment, the lower and upper hinge members being integrally formed with a door panel;

FIG. 3 shows the embodiment of FIG. 2 with a roller and weatherstrip adaptor;

FIG. 4 shows a cross-section of a second embodiment of a hinge assembly in accordance with the present invention, with FIGS. 4(a) to 4(g) showing sequential movement of the upper hinge member relative to the lower hinge member;

FIG. 5 shows use of the second embodiment with a mesh sheet;

FIG. 6 shows the second embodiment with a weatherstrip adaptor;

FIG. 7 shows use of the second embodiment with an integrally formed mesh sheet, with FIGS. 7(a) and 7(b) showing the sheet prior to expansion and FIG. 7(c) showing the sheet after expansion;

FIG. 8 shows a cross-section of a third embodiment of a hinge assembly in accordance with the present invention, with FIGS. 8(a) to 8(d) showing sequential movement of the upper hinge member relative to the lower hinge member;

FIGS. 9(a) and (b) show use of the third embodiment with two designs of wood panels; and

FIGS. 10(a) and (b) show weatherstrip adaptors for the panels of FIG. 9.

### DETAILED DESCRIPTION OF PREFERRED EMBODIMENTS

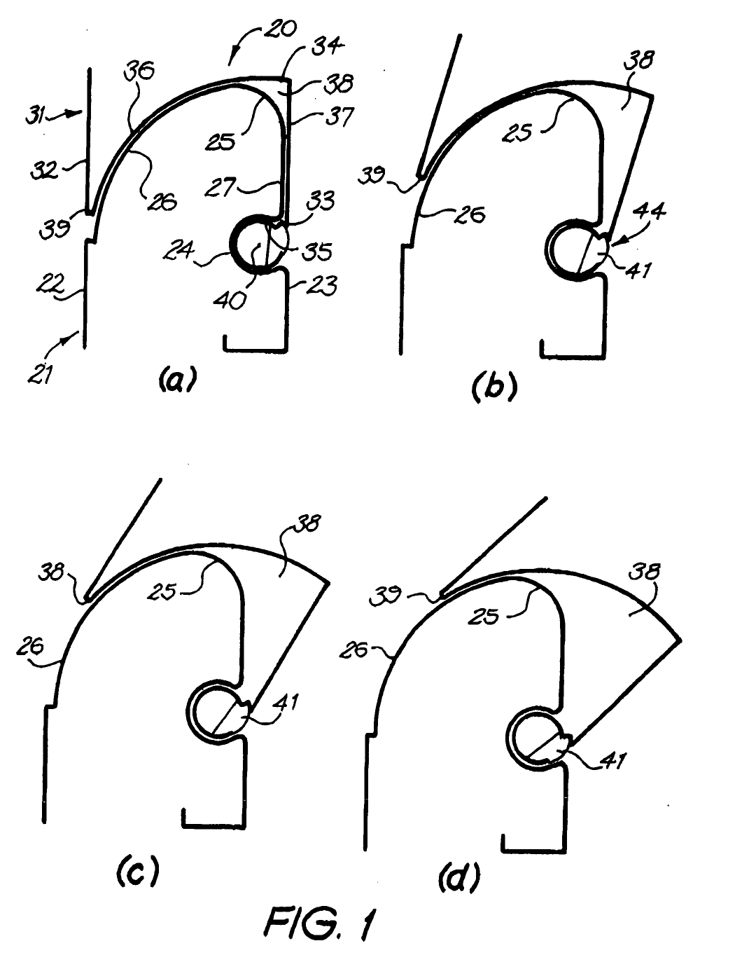

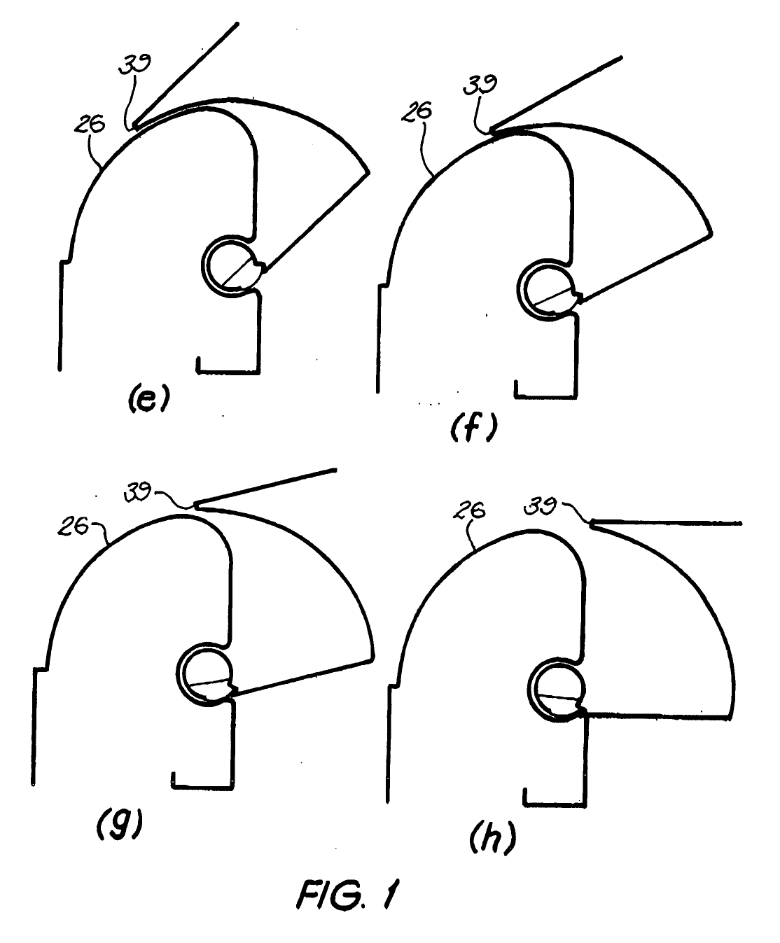

FIG. 1 shows a cross-section of a first embodiment of a hinge assembly 20 in accordance with the present invention. Referring to FIG. 1(a), the assembly 20 includes lower and upper hinge members 21, 31 which are pivotable relative to each other about a pivot axis 40.

The lower member 21 has a front portion 22, a rear portion 23, a longitudinal recess 24 adjacent the rear portion 23 which defines the pivot axis 40, and a projection 25 extending from the front portion 22 to the recess 24. The recess 24 is formed as a longitudinal substantially rounded socket. The projection 25 includes an arcuate surface 26 extending from the front portion 22, and a connection portion 27 which extends from the arcuate surface 26 to the recess 24. The arcuate surface 26 is spaced from the axis 40 by a fixed radius (the surface 26 has the axis 40 as its centre). The front portion 22, rear portion 23, and projection 25 all extend longitudinally parallel to the axis 40.

The upper hinge member 31 has a front portion 32, a rear portion 33, and a formation 34 extending from the front portion 32 to the rear portion 33. The rear portion 33 includes a pivot portion 35, which is formed as a longitudinal rounded projection, located in the lower member recess 24 such that the lower and upper members 21, 31 can pivot relative to each other about the hinge axis 40. The formation 34 includes an arcuate surface 36 extending from the front portion 32, and a connection portion 37 which extends from the arcuate surface 36 to the rear portion 33. The arcuate surface 36 is spaced from the axis 40 by a fixed radius (the surface 36 has the axis 40 as its centre), which radius is slightly larger than the radius of the arcuate surface 26. The surface 36 also defines an entrance portion 39 which is located adjacent the front portion 32. The formation 34 (arcuate surface 36 and connection portion 37) defines a cavity 38 into which the lower member projection 25 extends and moves as the lower hinge member 21 pivots relative to the upper hinge member 31.

FIGS. 1(a) to 1(h) sequentially show movement of the upper hinge member 31 relative to the lower hinge member 21. It can be seen that at substantially the entire range of movement of the upper member 31 relative to the lower member 21, the entrance portion 39 is always adjacent the arcuate surface 26. Thus, the insertion of a person's finger or any other object between the hinge members 21, 31 (between the entrance portion 39 and the arcuate surface 26) is substantially prevented.

The hinge assembly 20 can also include a longitudinal strip 41 which is located in a gap 44 in the pivot portion 35 to close the gap 44, which gap 44 is formed by the rollforming process. The strip 41 prevents a person's fingers from being inserted in the gap 44 such that both front and rear sides of the sectional door will include an insertion prevention means.

When used with sectional garage doors, the upper member 31 is attached to the bottom longitudinal edge of a first door panel and the lower member 21 is attached to the top longitudinal edge of a second (lower) door panel. The first and second door panels are then attached to each other by inserting the upper member pivot portion 35 into the lower member recess 24, such that the first and second panels can be pivoted relative to each other. Thus, by using the hinge assembly 20 with a sectional garage door, the insertion of a person's finger between the panels, on both the front and rear sides of the sectional door, is substantially prevented when the adjacent door panels pivot at the curved section of the garage door track.

In FIG. 1(h), there is a small gap between the entrance portion 39 and the arcuate surface 26. This figure however represents a position where the door panels are perpendicular to each other, which does not occur in typical sectional garage doors. The entrance portion 39 can be extended to avoid this gap, if required.

It can be seen that modifications can be made to the hinge assembly 20. For example, the surface 36 does not have to be arcuate. As long as the entrance portion 39 is spaced from the hinge axis 40 by a radius which is slightly larger than the radius of the arcuate surface 26, the entrance portion 39 will always be adjacent the arcuate surface 26 and the insertion of objects between the hinge members 21, 31 will be substantially prevented. The surface 36 can therefore be of any shape as long as it provides the cavity 38 for the projection 25.

Also, the arcuate surface 26 can be made from connected straight segments to form a substantially arcuate surface. As long as the entrance portion 39 is spaced from the surface 26 by a short distance during movement of the upper member 31 relative to the lower member 21, the insertion of objects between the hinge members 21, 31 will be substantially prevented. The hinge assembly 20 is preferably made from metal material and formed by rollforming.

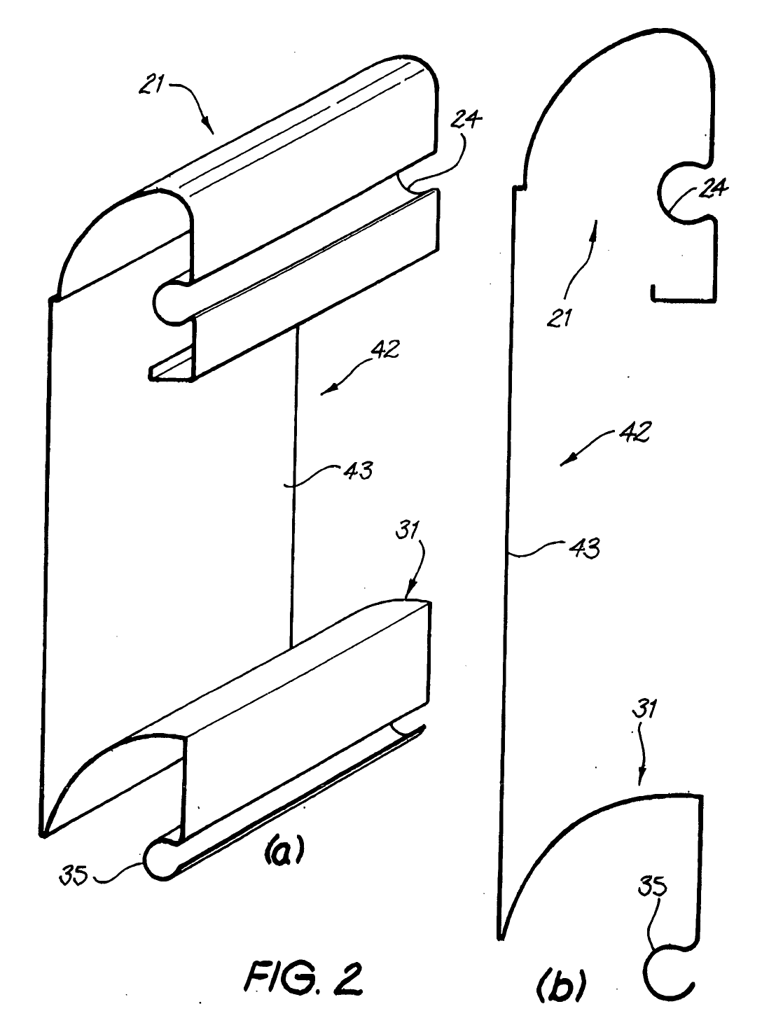

FIG. 2 shows a door panel 42 with the hinge assembly 20. The door panel 42 has a panel portion 43, the upper member 31 integrally formed at the bottom portion thereof and the lower member 21 integrally formed at the top portion thereof. The door panel 42 can then be attached to another door panel 42 by inserting the pivot portion 35 into the recess 24 of an adjacent panel, such that the panels can pivot relative to each other to form the garage door. The door panel 42 is preferably made from metal material and formed by rollforming.

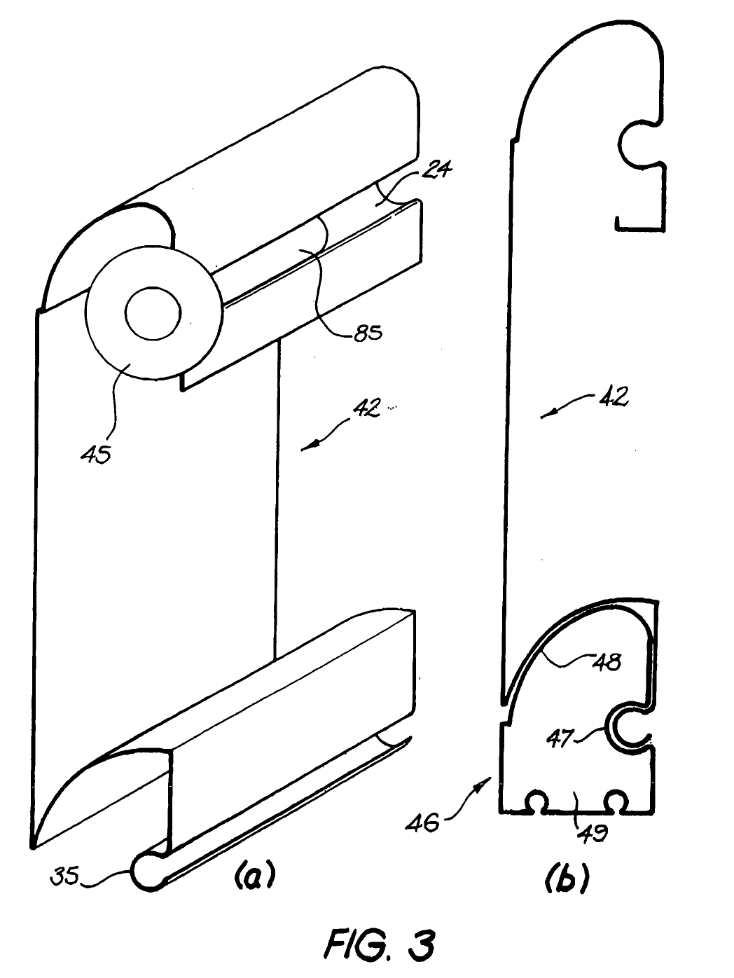

FIG. 3 shows the door panel 42 of FIG. 2 with a roller 45 and weatherstrip adaptor 46. The roller 45 includes an axle 85 which is inserted into the pivot portion 35 after insertion of the pivot portion 35 into a recess 24 of an adjacent panel. The roller 45 engages the track of the garage door assembly in use to allow the door panels to be moved from the track vertical section where the door panels block the building opening to the track horizontal section to allow passage through the opening.

The weatherstrip adaptor 46 includes a longitudinal recess 47 and longitudinal projection 48 which are similarly shaped as the recess 24 and the projection 25 of the lower hinge member 21. The recess 47 and projection 48 allows the adaptor 46 to pivot relative to the panel 42. The adaptor 26 is substantially co-extensive with the door panel 42 and is attached to the lowermost panel 42 of a garage door. The adaptor 26 includes a bottom portion 49 which abuts the ground surface when the garage door is lowered to protect the lowermost panel 42 and to substantially seal the garage against rain. The bottom portion 49 can include rubber sealing strips.

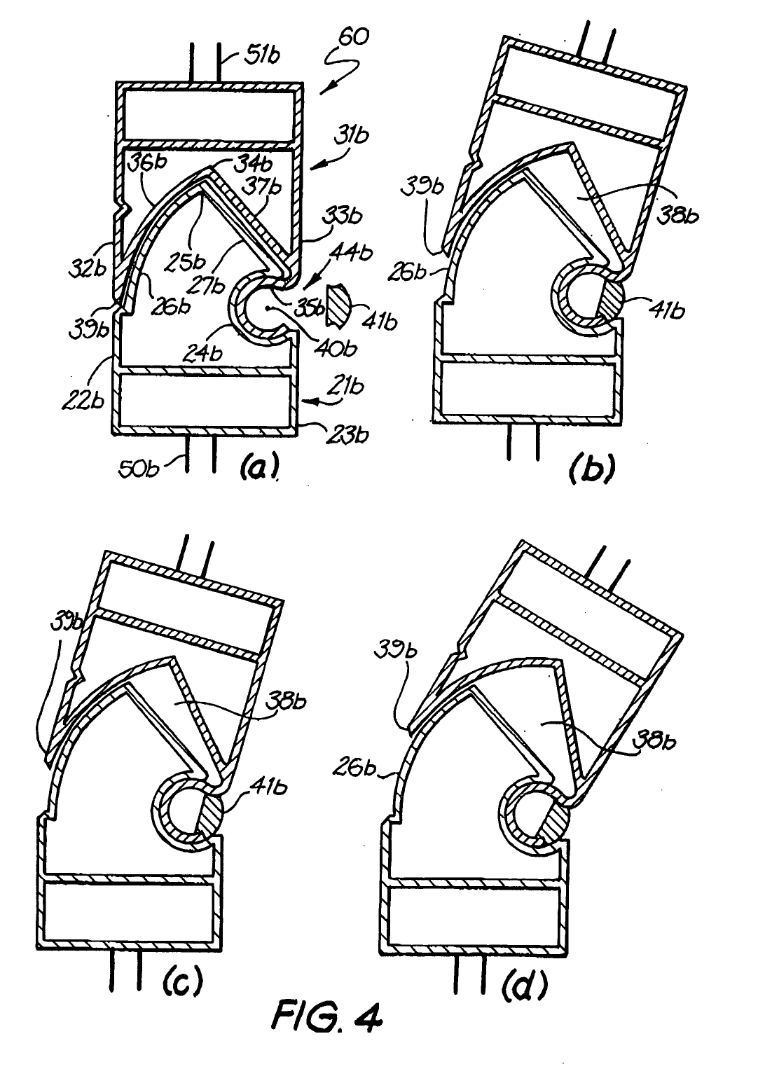

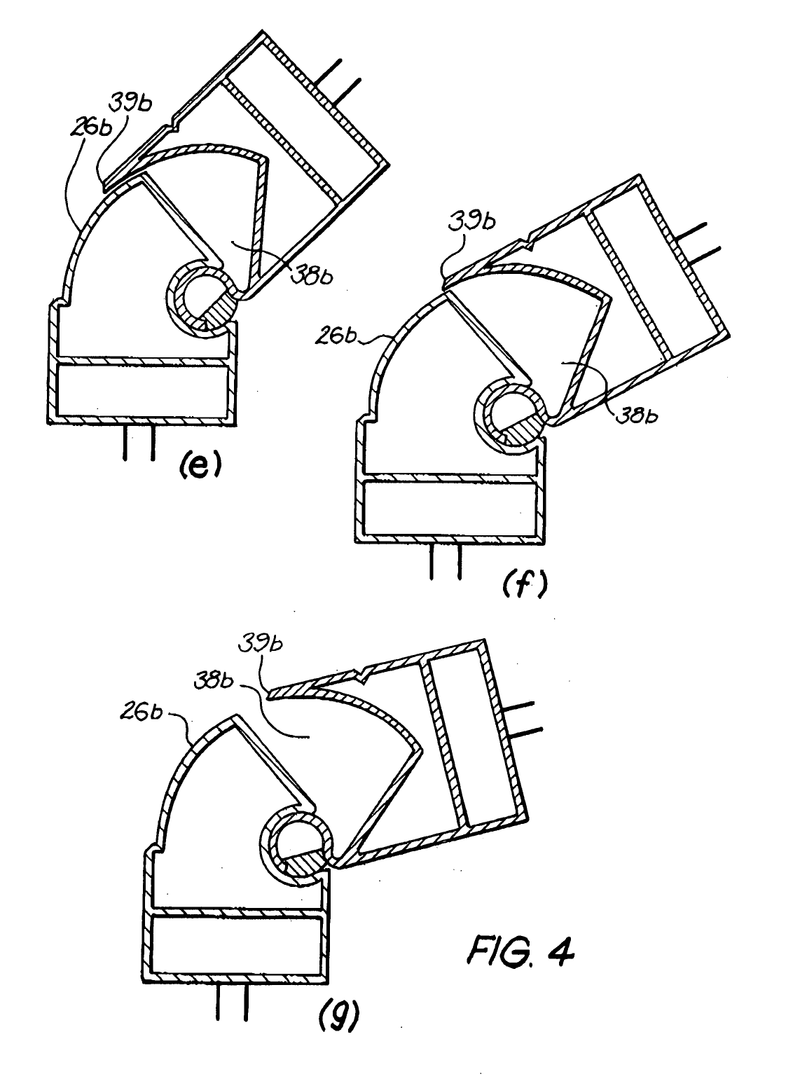

FIG. 4 shows a cross-section of a second embodiment of a hinge assembly 60 in accordance with the present invention. The hinge assembly 60 is similar in shape and operation to the hinge assembly 20. Similar parts will therefore be referred to with similar reference numerals as the hinge assembly 20, but will include the suffix “b”.

Referring to FIG. 4(a), the assembly 60 includes lower and upper hinge members 21b, 31b which are pivotable relative to each other about a pivot axis 40b. The lower member 21 b has a front portion 22b, a rear portion 23b, a longitudinal recess 24b adjacent the rear portion 23b which defines the pivot axis 40b, and a projection 25b extending from the front portion 22b to the recess 24b. The projection 25b includes an arcuate surface 26b extending from the front portion 22b, and a connection portion 27b which extends from the arcuate surface 26b to the recess 24b. The arcuate surface 26b is spaced from the axis 40b by a fixed radius (the arcuate surface 26b has the axis 40b as its centre). The front portion 22b, rear portion 23b, and projection 25b all extend longitudinally parallel to the axis 40b. The lower hinge member 21b also includes an attachment portion 50b at a bottom portion thereof for attachment to a door panel, as described below.

The upper hinge member 31b has a front portion 32b, a rear portion 33b, and a formation 34b extending from the front portion 32b to the rear portion 33b. The rear portion 34b includes a pivot portion 35b located in the lower member recess 24b such that the lower and upper members 21 b, 31 b can pivot relative to each other about the hinge axis 40b. The formation 34b includes an arcuate surface 36b extending from the front portion 32b, and a connection portion 37b which extends from the arcuate surface 36b to the rear portion 33b. The arcuate surface 36b is spaced from the axis 40b by a fixed radius (the surface 36b has the axis 40b as its centre), which radius is slightly larger than the radius of the arcuate surface 26b. The surface 36b also defines an entrance portion 39b which is located adjacent the front portion 32b. The formation 34b (arcuate surface 36b and connection portion 37b) defines a cavity 38b into which the lower member projection 25b extends and moves as the lower hinge member 21b pivots relative to the upper hinge member 31b. The upper hinge member 31b also includes an attachment portion 51 b at a top portion thereof for attachment to a door panel, as described below.

FIGS. 4(a) to 4(g) sequentially show movement of the upper hinge member 31b relative to the lower hinge member 21b. It can be seen that at substantially the entire range of movement of the upper member 31b relative to the lower member 21b, the entrance portion 39b is always adjacent the arcuate surface 26b. Thus, the insertion of a person's finger or any other object between the hinge members 21b, 31b (between the entrance portion 39b and the arcuate surface 26b) is substantially prevented.

The hinge assembly 60 can also include a longitudinal strip 41b which is located in a gap 44b in the pivot portion 35b to close the gap 44b, to prevent a person's fingers from being inserted in the gap 44b. The hinge assembly 60 is preferably formed by extrusion process, from suitable metal or plastics material.

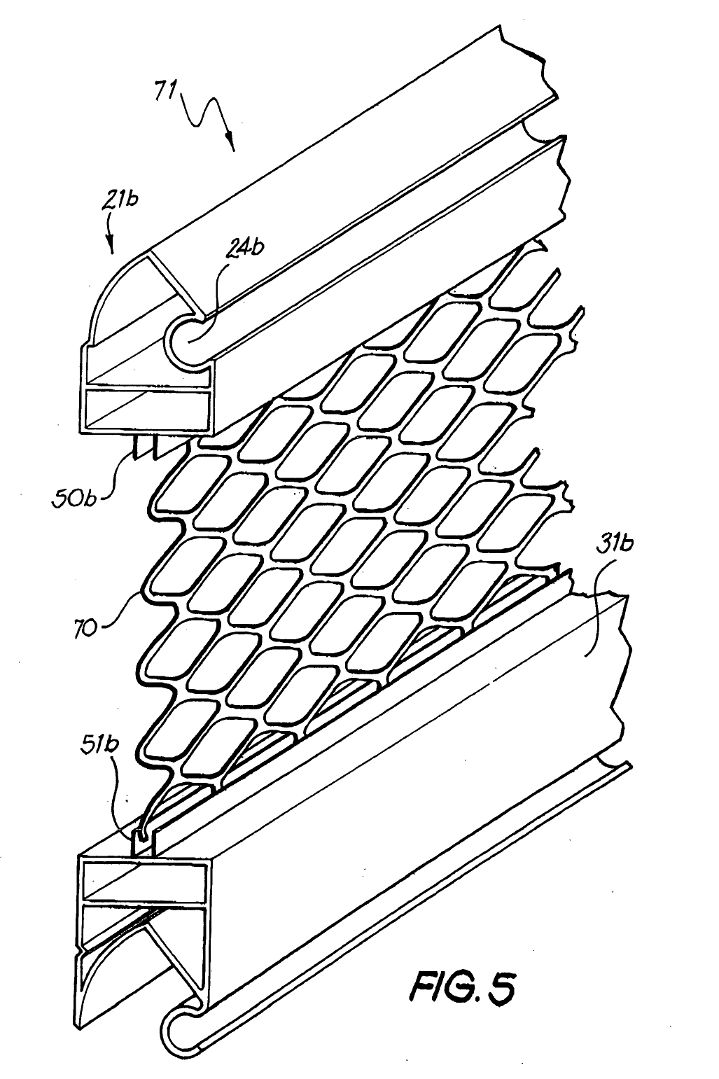

FIG. 5 shows use of the second hinge assembly with a mesh sheet 70. The bottom edge of the sheet 70 is attached to the attachment portion 51b of the upper hinge member 31b, and the top edge of the sheet 70 is attached to the attachment portion 50b of the lower hinge member 21b, to form a door panel sub-assembly 71. A garage door using such sub-assemblies 71 can then be assembled by forming further sub-assemblies 71, and attaching such sub-assemblies 71 together by inserting the pivot portion 35b to the longitudinal recess 24b of an adjacent (lower) sub-assembly 71.

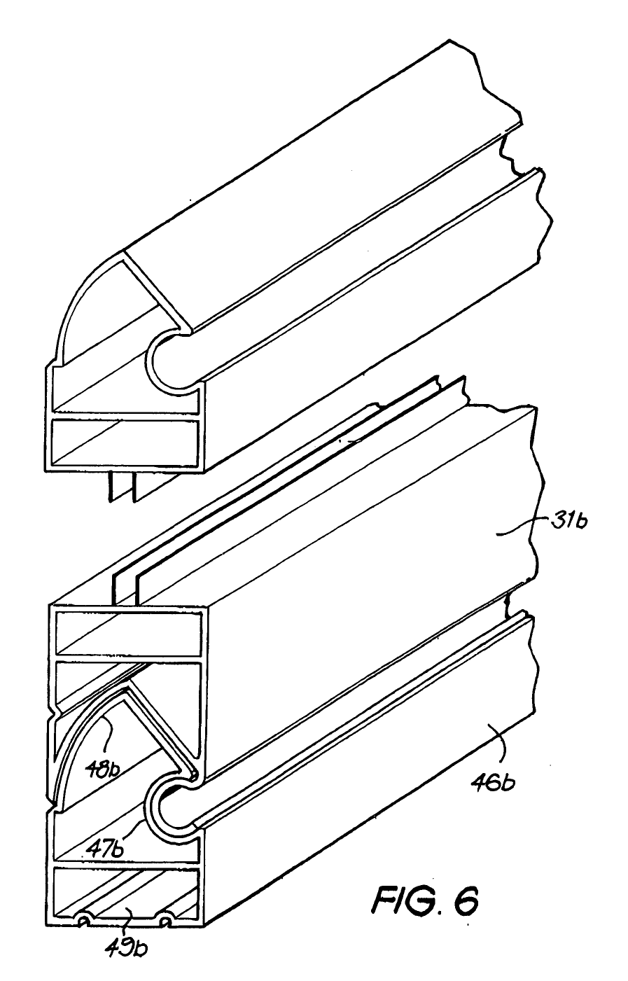

FIG. 6 shows the hinge assembly 60 with a weatherstrip adaptor 46b, which is similar to the weatherstrip adaptor 46 of the hinge assembly 20. The weatherstrip adaptor 46b includes a longitudinal recess 47b and longitudinal projection 48b which are similarly shaped as the recess 24b and the projection 25b of the lower hinge member 21b. This allows the adaptor 46b to pivot relative to the upper hinge member 31b. The adaptor 46b is attached to the lowermost panel of a garage door. The adaptor 46b includes a bottom portion 49b which abuts the ground surface when the garage door is lowered to protect the lowermost panel and to substantially seal the garage against rain.

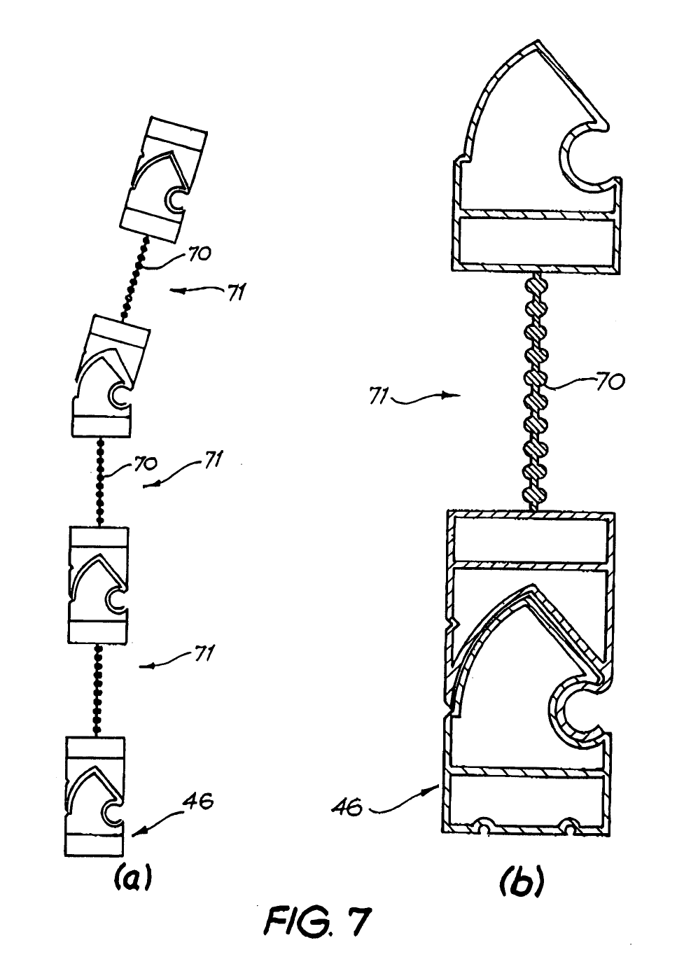

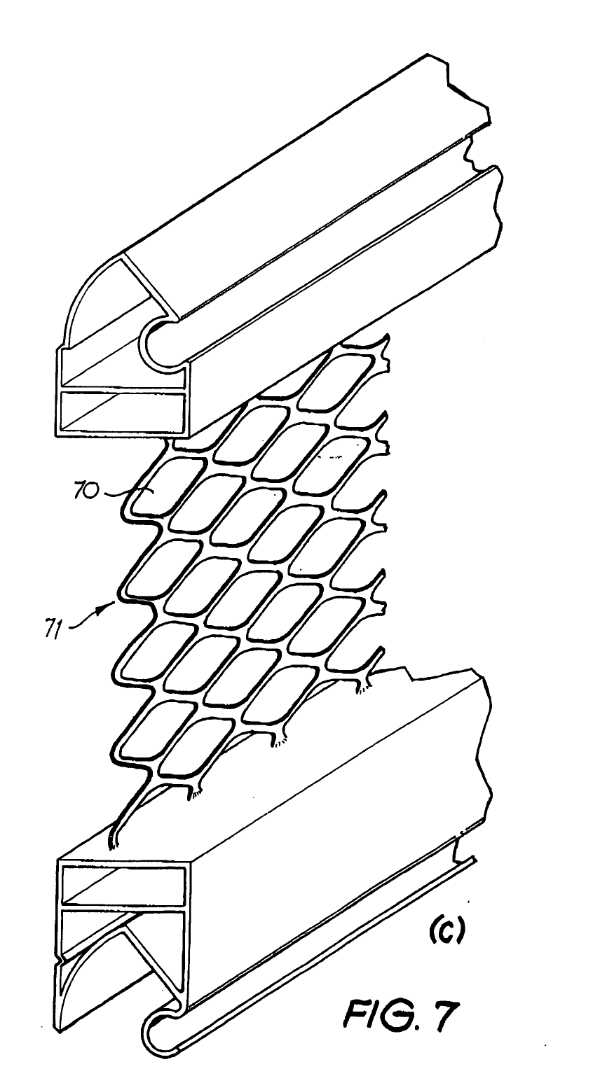

FIG. 7 shows use of the hinge assembly 60 with an integrally formed mesh sheet. In this embodiment, the sub-assembly 71 shown in FIG. 5 is formed as an integral sub-assembly 71 by extrusion process from suitable metal material. FIGS. 7(a) and 7(b) show the sheet prior to expansion. The sheet 70 between the hinge members 21b, 31b is perforated to provide the mesh holes. FIG. 7(c) shows the sheet after expansion. The perforations in the sheet allow same to expand to form the mesh.

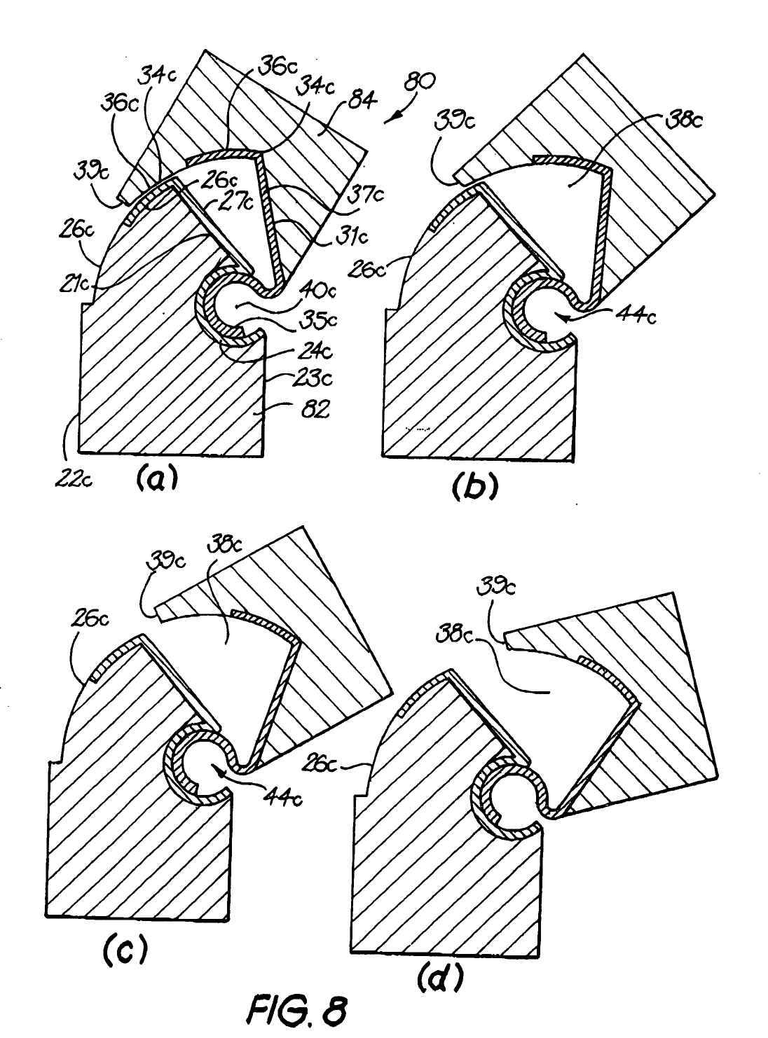

FIG. 8 shows a cross-section of a third embodiment of a hinge assembly 80 in accordance with the present invention. The hinge assembly 80 is similar in shape and operation to the hinge assemblies 20, 60. Similar parts will therefore be referred to with similar reference numerals as the hinge assembly 20, but will include the suffix “c”.

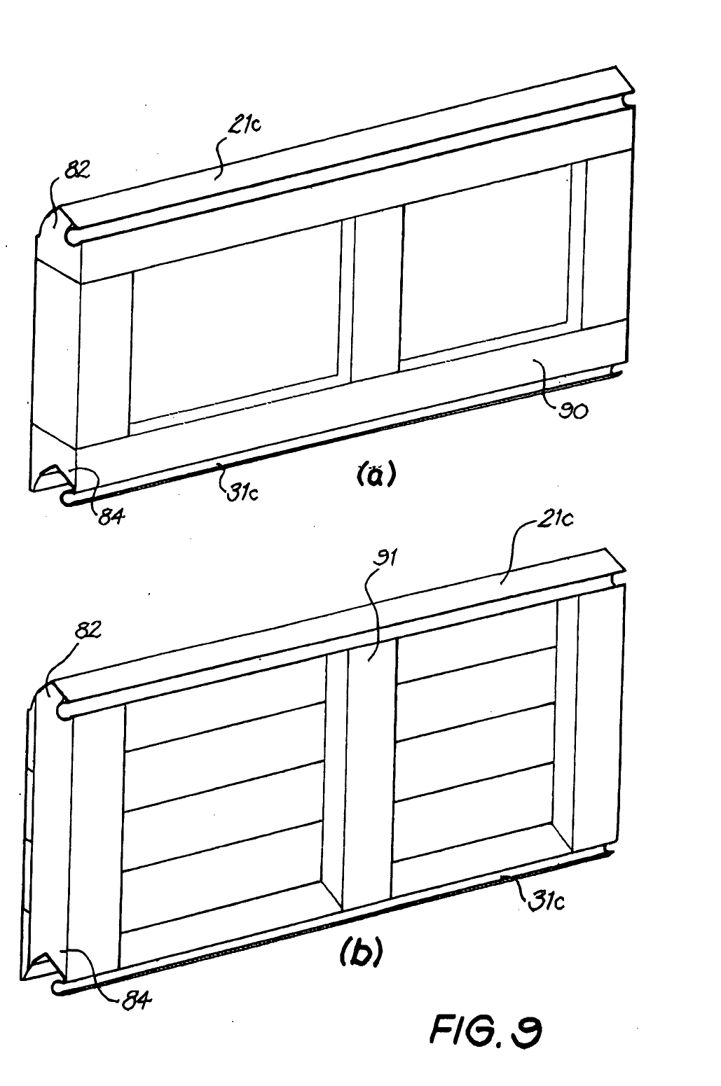

As the hinge assembly 80 is similar in shape and operation to the hinge assemblies 20, 60, a detailed description of the hinge assembly 80 will not be given. The main difference is that the hinge assembly 80 includes lower and upper hinge members 21c, 31c which are attached to first and second panel pieces 82, 84, respectively. The panel pieces 82, 84 can be portions of door panels (as will be described below with reference to FIG. 9) or parts which are to be attached to the door panels.

In this embodiment, the longitudinal recess 24c, the connection portion 27c and part of the arcuate surface 26c is formed by the lower member 21c. The remainder of the arcuate surface 26c, front portion 22c and rear portion 23c is formed by the panel piece 82. Thus, the panel piece 82 forms an extension or part of the arcuate surface 26c. In the upper hinge member 31c, the pivot portion 35c, the connection portion 37c and part of the arcuate surface 36c is formed by the upper member 31c. The remainder of the arcuate surface 36c, front portion 32c, rear portion 33c and entrance portion 39c is formed by the panel piece 84. Thus, the panel piece 84 forms an extension or part of the entrance portion 39c.

FIGS. 8(a) to 8(d) sequentially show movement of the upper hinge member 31c relative to the lower hinge member 21c. As with the hinge assemblies 20, 60, the insertion of a person's finger or any other object between the entrance portion 39c and the arcuate surface 26c is substantially prevented. The hinge assembly 80 also preferably includes a longitudinal strip (not shown) similar to the strips 41, 41b, which is located in a gap 44c in the pivot portion 35c to prevent a person's fingers from being inserted in the gap 44c. The lower and upper hinge members 21c, 31c are preferably formed by extrusion process from suitable metal or plastics material. The hinge members 21c, 31c are designed to be attached to wood panels, which can form the panel pieces 82, 84.

FIG. 9 shows use of the hinge assembly 80 with two designs of wood panels. The hinge members 21c, 31c are attached to the top and bottom edges, respectively, of the wood panels 90, 91. The top and bottom edges of the wood panels 90, 91 are shaped to form the panel pieces 84, 82, as described above. It can be seen that the hinge members 21c, 31c provide the pivot portions of the hinge assembly 80, whilst the panels 90, 91 form parts of the cavity 38c and projection 25c of the hinge assembly 80.

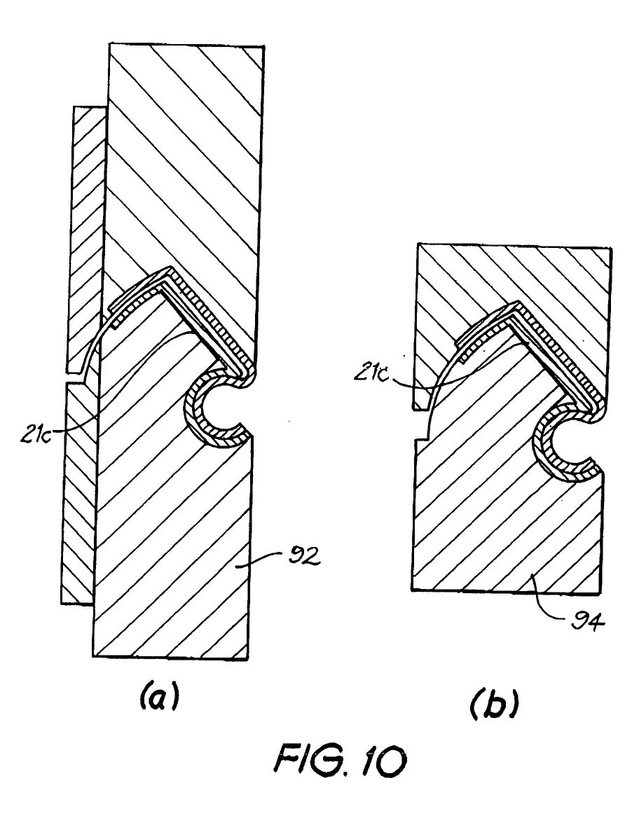

FIG. 10 shows weatherstrip adaptors 92, 94 for the panels 90, 91 respectively. These adaptors 92, 94 include a hinge member 31c for attaching to the lowermost panel of the garage door, similar to the adaptors 46 described above. The front portions of the adaptors are shaped to correspond to the design of the corresponding panel 90, 91

Lubrication can be provided between the recess and pivot portions of the hinge members of the above embodiments to provide a smooth pivoting movement. Such lubrication can be in the form of gel lubricants, carbon tape and the like.

Although the present invention has been described with reference to particular embodiments, it will be appreciated that numerous variations and modifications will become apparent to persons skilled in the art. For example, the hinge assemblies can alternatively use conventional hinges to provide pivoting movement between the hinge members, rather than having the recess and pivot portions. It is also possible for the panel top and bottom longitudinal edges to form the entire projection, cavity and entrance portions to prevent insertion of objects between the panels.

1. A hinge assembly having a generally horizontal pivot axis, the assembly including:
a lower hinge member, said lower member having a longitudinal recess providing said axis and a projection extending longitudinally parallel to said axis, the projection having a longitudinal substantially arcuate surface spaced from said axis by a fixed radius; and
an upper hinge member, said upper member having a pivot portion located in said recess so that the members can pivot relative to each other about said axis, the upper hinge member further having a cavity into which said projection extends and moves, said cavity having an entrance portion located at a fixed radius relative to said axis and extending longitudinally parallel to said axis, the entrance portion being located adjacent said substantially arcuate surface of said lower member.

2. The hinge assembly of claim 1, wherein the projection includes the substantially arcuate surface and a connection portion extending from the substantially arcuate surface to the recess.

3. The hinge assembly of claim 1, wherein the cavity in the upper hinge member is defined by a substantially arcuate surface extending from the entrance portion, and a connection portion extending from the substantially arcuate surface to the pivot portion.

4. The hinge assembly of claim 2 wherein the connection portion is flat.

5. The hinge assembly of claim 1 wherein the recess is formed as a longitudinal substantially rounded socket.

6. The hinge assembly of claim 5 wherein the pivot portion is formed as a longitudinal substantially closed and substantially rounded projection.

7. The hinge assembly of claim 6 wherein the pivot portion is fully closed.

8. The hinge assembly of claim 1 wherein the lower hinge member includes an attachment portion at a bottom portion thereof for attachment to a sectional overhead door panel.

9. The hinge assembly of claim 1 wherein the upper hinge member includes an attachment portion at a top portion thereof for attachment to a sectional overhead door panel.

10. A sectional overhead door panel having the hinge assembly of claim 1, wherein the lower hinge member is attached to the top longitudinal edge of the door panel and the upper hinge member is attached to the bottom longitudinal edge of the door panel.

11. The door panel of claim 10 wherein the door panel forms an extension or part of the substantially arcuate surface of the lower hinge member.

12. The door panel of claim 10 wherein the door panel forms an extension or part of the entrance portion of the upper hinge member.

13. A sectional overhead door panel having the hinge assembly of claim 1, wherein the lower hinge member is integrally formed with the top longitudinal edge of the door panel and the upper hinge member is integrally formed with the bottom longitudinal edge of the door panel.

14. A sectional overhead door assembly to be mounted adjacent a building opening, the door assembly including
first and second generally parallel, transversely spaced and co-extensive tracks, each track having a substantially vertical section to extend along each side of the building opening, a substantially horizontal section to extend adjacent a ceiling of said building, and a curved section extending between the vertical and horizontal sections,
a plurality of door panels to each extend between said tracks, each door panel having a hinge assembly according to claim 1, each door panel having the lower hinge member at a top longitudinal edge thereof and the upper hinge member at a bottom longitudinal edge thereof such that each panel can be pivotably connected to an adjacent panel,
rollers to be mounted to ends of said hinge members to engage said tracks,
wherein, in use, the tracks and rollers allow the door panels to be moved from the track vertical section where the door panels block the building opening to the track horizontal section to allow passage through the opening.

15. The sectional overhead door assembly of claim 14 further including a weather adaptor substantially co-extensive with said door panels, the adaptor having the longitudinal recess and longitudinal projection of the lower hinge member, the adaptor to be attached to the lowermost panel of the assembly.

16. The sectional overhead door assembly of claim 15 wherein the adaptor includes a flat bottom portion.

17. The sectional overhead door assembly of claim 16 wherein the adaptor bottom portion includes a rubber sealing strip.
